(19) United States
(12) Patent Application Publication
(10) Pub. No.: US 2022/0041883 A1
(43) Pub. Date: Feb. 10, 2022

(54) TEXTILE PRINTING

(71) Applicant: Hewlett-Packard Development Company, L.P., Spring, TX (US)

(72) Inventors: Dennis Z. Guo, San Diego, CA (US); Jie ZHENG, San Diego, CA (US)

(73) Assignee: Hewlett-Packard Development Company, L.P., Spring, TX (US)

(21) Appl. No.: 17/433,301

(22) PCT Filed: Sep. 27, 2019
(86) PCT No.: PCT/US2019/053411

§ 371 Date: Aug. 24, 2021

(51) Int. Cl. C09D 11/54; C09D 11/322; C09D 11/38; C09D 11/102; D06P 1/52; D06P 5/00; D06P 5/30; C09D 11/36

(52) U.S. Cl. CPC C09D 11/54; C09D 11/322; C09D 11/38; C09D 11/36; D06P 1/5292; D06P 5/002; D06P 5/30; C09D 11/102

(57) ABSTRACT

A fluid set for textile printing includes a pre-treatment composition, a fixer composition, and a white ink composition. The pre-treatment composition includes a pre-treatment composition including a surfactant-free dispersion of siloxane polymer or C10 to C24 alkyl chain-modified polymer, a fixer composition including a cationic polymer and a fixer vehicle, and a white ink composition including a white pigment, a polymeric binder, and an ink vehicle.

### BACKGROUND

Textile printing methods often include rotary and/or flat-screen printing, often including the creation of a plate or a screen. Both of these analog types of printing can have great throughput capacity, but may have size limitations and initial setup that involves creating a screen, for example. Inkjet printing, on the other hand, is a non-impact printing method that utilizes electronic signals to control and direct droplets or a stream of ink to be deposited on media. Thus, with digital printing, if white ink compositions or related fluid sets can be prepared that have similar properties, e.g., durability, image quality, etc. as the more conventional fabric printing analog methods, users could benefit from enhanced printing flexibility, e.g., wider size ranges printed more immediately from an electronic image, with similar durability and image quality.

### BRIEF DESCRIPTION OF THE DRAWINGS

FIG. 1 schematically illustrates an example fluid set for white textile printing in accordance with the present disclosure;

FIG. 2 schematically illustrates an example printing kit for printing white images on textile fabrics in accordance with the present disclosure;

FIG. 3 is a flow diagram illustrating an example method of printing white images on textile fabrics in accordance with the present disclosure; and

FIG. 4 is a schematic diagram of an example of method of printing white images with the fluid set as shown on textile fabrics using the example printing kit shown in FIG. 2 and an example printing system, in accordance with the present disclosure.

### DETAILED DESCRIPTION

The textile market is a major industry, and printing on textiles, such as cotton, etc., has been evolving to include digital printing methods. Some digital printing methods enable direct to garment (or other textile) printing. White ink is a heavily used ink in direct to garment printing. Obtaining white images with desirable opacity, however, may be challenging, in part because of fibrillation, e.g., hair-like fibers sticking out of the fabric surface. To control fibrillation and to achieve a suitable opacity of a white image on a colored garment, in accordance with the present disclosure, a pre-treatment composition can be applied prior to application of fixer composition and white ink composition thereon.

In accordance with this, the present disclosure is drawn to fluid sets for textile printing white images, for example. One example fluid set includes a pre-treatment composition having an emulsified polymer therein, the emulsified polymer including an emulsified siloxane polymer having a D50 particle size from 1 nm to 40 nm, an emulsified C10 to C24 alkyl chain-modified polymer, or a combination thereof. The fluid set also includes a fixer composition including a cationic polymer and a fixer vehicle, and further includes a white ink composition including a white pigment, a polymeric binder, and an ink vehicle. In one example, the emulsified siloxane polymer can includes a substituted dimethyl silicone with a plurality of methyl groups substituted with 3-mercapto-propyl, 3-((2-aminoethyl)-amino)propyl, or a combination thereof. In another example, the pre-treatment composition can include the emulsified C10 to C24 alkyl chain-modified polymer in the form of an emulsified stearylated polymer, and the emulsified stearylated polymer has as D50 stearylated polymer size from 5 nm to 1 μm. If the emulsified polymer is the emulsified siloxane polymer, it may have an example weight average molecular weight from 1,000 Mw to 100,000 Mw. When the emulsified polymer is the emulsified stearylated polymer, it may have an example weight average molecular weight from 1,000 Mw to 100,000 Mw. The pre-treatment composition can be an analog application fluid or a digital printing fluid with a viscosity from 1 cps to 100 cps at 25° C. The fixer composition and the white ink composition can both be digital printing fluids individually having viscosities from 1 cps to 30 cps at 25° C. The emulsified polymer can be present in the pre-treatment composition at from 4 wt % to 25 wt %. With respect to the fixer composition, the cationic polymer can be, for example, selected from poly(diallyldimethylammonium chloride); or poly(methylene-co-guanidine) anion with the anion is selected from the hydrochloride, bromide, nitrate, sulfate, or sulfonate; a polyamine; poly(dimethylamine-co-epichlorohydrin); a polyethylenimine; a polyamide epichlorohydrin resin; a polyamine epichlorohydrin resin; or a combination thereof. The white pigment can include titanium dioxide, zinc oxide, zirconium dioxide, or a combination thereof, and can be present in the white ink composition at from 4 wt % to 15 wt %. In one example, the pre-treatment composition can include the emulsified siloxane polymer, and the emulsified siloxane polymer can be emulsified in the absence of a surfactant.

In another example, a textile printing kit includes a textile fabric, a pre-treatment composition having an emulsified polymer therein, a fixer composition including a cationic polymer and a fixer vehicle, and a white ink composition including a white pigment, a polymeric binder, and an ink vehicle. The emulsified polymer in this example includes an emulsified siloxane polymer having a D50 particle size from 1 nm to 40 nm, an emulsified C10 to C24 alkyl chain-modified polymer, or a combination thereof. In one example, the textile fabric can be selected from polyester fabric, polyester blend fabric, cotton fabric, cotton blend fabric, nylon fabric, nylon blend fabric, silk fabric, silk blend fabric, wool fabric, wool blend fabric, or a combination thereof. In one example, the textile fabric can be a dark fabric having an L* value from 20 to 50.

In another example, a textile printing method includes applying a pre-treatment composition on a textile fabric to form a pre-treatment layer, the pre-treatment composition including an emulsified siloxane polymer having a D50 particle size from 1 nm to 40 nm, an emulsified C10 to C24 alkyl chain-modified polymer, or a combination thereof. The method further includes applying heat to the pre-treatment layer on the textile fabric to form a pre-treatment film, and applying a fixer composition (which includes including a cationic polymer and a fixer vehicle) on the pre-treatment film to form a fixer layer. The method further includes digitally printing a white ink composition on the fixer layer to form a white ink layer, wherein the white ink composition includes a white pigment, a polymeric binder, and an ink vehicle. Furthermore, the method includes thermally curing the white ink layer on the textile fabric to form a white image. In one example, the pre-treatment composition can be digitally printed on the textile fabric at from 10 gsm to 100 gsm. In another example, the heat applied to the pre-treatment layer on the textile fabric can range from 120° C. to 200° C. In some more specific examples, pressure can also be applied to the pre-treatment layer on the textile fabric can range from 1.5 psi to 120 psi. The heat and pressure, in this example, can be applied to pre-treatment layer on the textile fabric can be for a period of time ranging from 10 seconds to 30 minutes.

It is noted that when discussing the fluid sets, the textile printing kits, and the methods herein, these various discussions can be considered applicable to each of these examples, whether or not they are explicitly discussed in the context of that example. Thus, for example, in discussing a white pigment in the context of a fluid set, the white pigment disclosure is also applicable to the textile printing kits and method examples, and vice versa.

Furthermore, features of examples of the present disclosure will become apparent by reference to the detailed description herein, including the drawings, in which like reference numerals correspond to similar, though perhaps not identical, components. For the sake of brevity, reference numerals or features having a previously described function may or may not be described in connection with other drawings in which they appear.

A fluid set that is suitable for obtaining white images with good opacity, image quality, and/or durability, e.g., washfastness, on textile fabric, even dark colored textile fabric, is disclosed herein. The fluid set includes a pre-treatment composition, a fixer composition, and a white ink composition. The pre-treatment composition may include an emulsified polymer, such as an emulsified polysiloxane polymer or an emulsified C10 to C24 alkyl chain-modified polymer.

These emulsions can provide a composition that decreases fibrillation by forming a film on the fibers of the textile and/or in the pores between the fibers of the textile. This film can be more hydrophobic than the textile alone, and thus subsequently deposited ink is not able to penetrate into the textile as rapidly. This enables the fixer composition (which is applied on the film prior to the white ink composition) more time to react with the white ink composition, which in turn enables the pigment to become fixed at the surface of the textile. As such, the combination of the pre-treatment composition, the fixer composition, and the white ink composition can provide good opacity and image quality of white images printed on colored textiles. Furthermore, relatively small amounts of the pre-treatment composition (e.g., less than 100 gsm) may be used to achieve the white images, and thus the amount of energy and time involved in drying and/or curing is reduced.

With respect to opacity specifically, the opacity may be measured in terms of L* (or lightness) of the white print generated with the fluid set disclosed herein on a colored textile fabric. A greater L* value indicates a higher opacity of the white ink on the colored textile fabric. L* is measured in the CIELAB color space, and may be measured using any suitable color measurement instrument (such as those available from HunterLab or X-Rite). The white ink composition, when printed on the colored textile fabric pretreated with the pre-treatment composition and the fixer composition disclosed herein, may generate prints that have an L* value that is greater than prints generated on the same colored textile fabric with the same inkjet and one of: i) without the pre-treatment composition and without pre-heating, ii) without the pre-treatment composition but with pre-heating, iii) with water and pre-heating as the pre-treatment technique, or iv) with water and squeegeeing as the pre-treatment technique.

The durability of a print on a fabric may be assessed by its ability to retain color after being exposed to washing. This is also known as washfastness. Washfastness can be measured in terms of ΔE. The term “ΔE,” as used herein, refers to the change in the L*a*b* values of a color (e.g., cyan, magenta, yellow, black, red, green, blue, white) after washing. ΔE can be calculated by different equations, such as the CIEDE1976 (or ΔE_{CIE}) color-difference formula, and the CIEDE2000 (or ΔE₂₀₀₀) color-difference formula. ΔE can also be calculated using the color difference method of the Color Measurement Committee (ΔE_{CMC}).

### Fluid Sets for Textile Printing

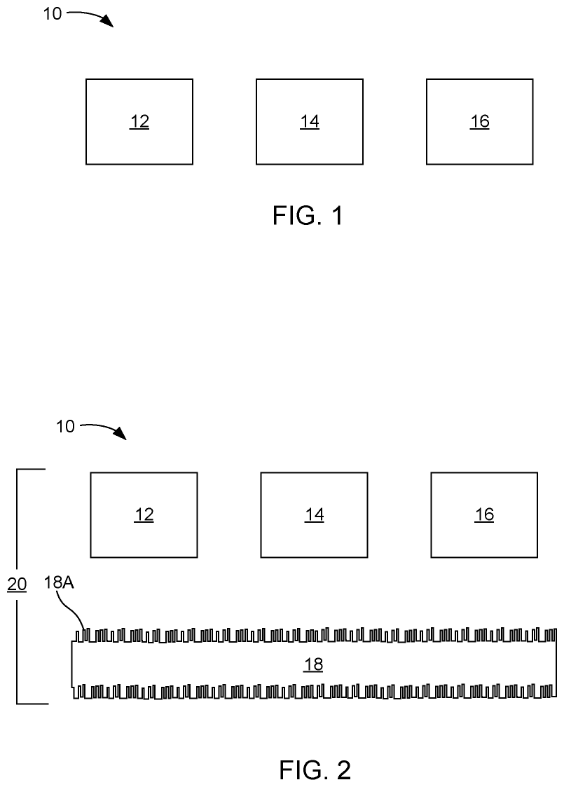

As shown in FIG. 1, a fluid set 10 can include a pre-treatment composition 12 including an emulsified polymer, such as an emulsified siloxane polymer, an emulsified C10 to C24 alkyl chain-modified polymer, or a combination thereof.

A fixer composition 14 can also be included, which includes a cationic polymer and a fixer vehicle. A white ink composition 16 can also be included, which includes a white pigment, a polymeric binder, and an ink vehicle. In one example, the fluid set includes a pre-treatment composition that is formulated for analog application (e.g., spraying), and a fixer composition and a white ink composition that are formulated for thermal inkjet printing. In another example, the fluid set includes a pre-treatment composition, a fixer composition, and a white ink composition that are formulated for thermal inkjet printing. In still another example, the fluid set includes a pre-treatment composition, a fixer composition, and a white ink composition that are formulated for piezoelectric inkjet printing or another type of digital printing. In any example of the fluid set, the pre-treatment composition, the fixer composition, and the white ink composition may be maintained in separate containers (e.g., respective reservoirs/fluid supplies of respective inkjet cartridges) or separate compartments (e.g., respective reservoirs/fluid supplies) in a single container (e.g., inkjet cartridge).

### Textile Printing Kits

As shown in FIG. 2, the fluid set 10 may also be part of a textile printing kit 20. In an example, the textile printing kit includes a textile fabric 18, as well as the fluid set components shown and described in FIG. 1. More specifically, the fluid set can include a pre-treatment composition 12 including an emulsified polymer, such as an emulsified siloxane polymer, an emulsified C10 to C24 alkyl chain-modified polymer, or a combination thereof. The fluid set can also include a fixer composition 14, which includes a cationic polymer and a fixer vehicle. A white ink composition 16 can also be included, which includes a white pigment, a polymeric binder, and an ink vehicle. As shown in FIG. 2, often with many types of fabrics, e.g., cotton fabrics, there may be hair-like fibers 18A that can extend from the textile fabric substrate material, and these fibers can cause problems with printability, particularly with dark fibers used in combination with white inks. In accordance with the present disclosure, in some instances, the use of the pre-treatment composition together with the heat press can flatten the hair-like fibers and reduce the penetration of fixer and white ink into the fabric, thus improving opacity and image quality in some instances.

### Textile Printing Methods

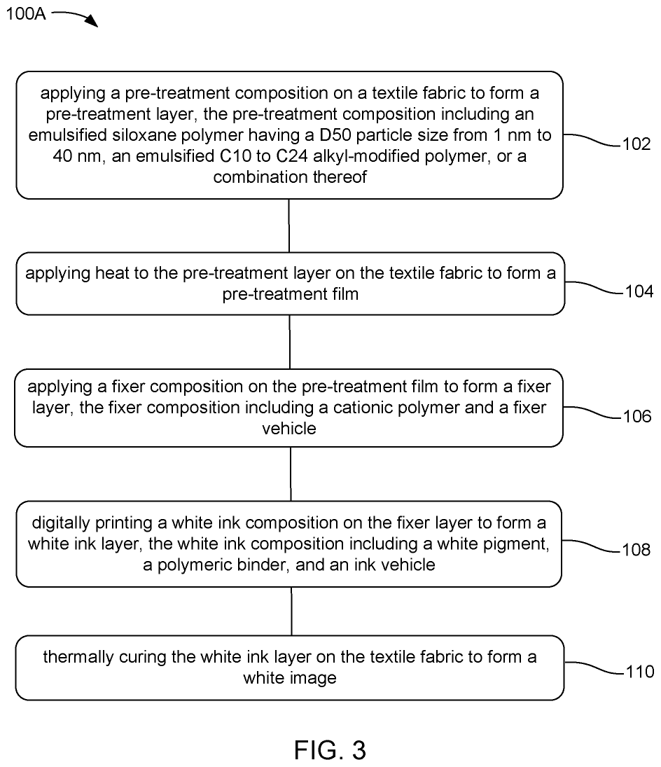

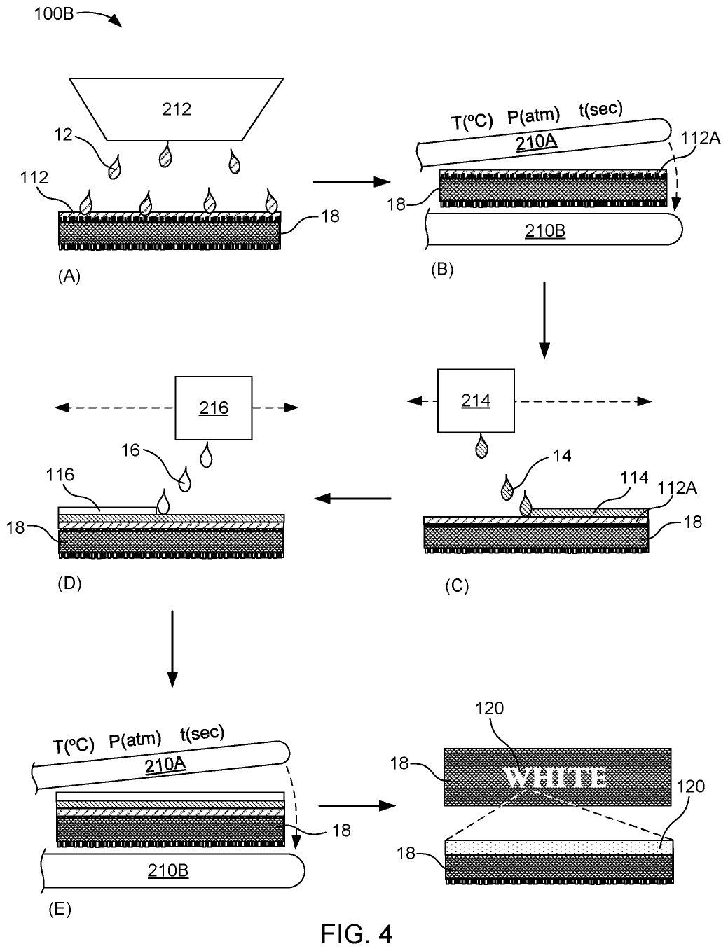

Example textile printing methods are illustrated at 100A in FIG. 3 and at 1006 in FIG. 4. In FIG. 3 more specifically, a flow diagram of a method of textile printing includes applying 102 a pre-treatment composition on a textile fabric to form a pre-treatment layer, the pre-treatment composition including an emulsified siloxane polymer having a D50 particle size from 1 nm to 40 nm, an emulsified C10 to C24 alkyl chain-modified polymer, or a combination thereof. The method further includes applying heat 104 to the pre-treatment layer on the textile fabric to form a pre-treatment film, and applying 106 a fixer composition (which includes including a cationic polymer and a fixer vehicle) on the pre-treatment film to form a fixer layer. Applying can be by digitally printing, for example, or by some other application method, digital or analog. The method further includes digitally printing 108 a white ink composition on the fixer layer to form a white ink layer, wherein the white ink composition includes a white pigment, a polymeric binder, and an ink vehicle. The fixer and white ink can be applied multiple times to reach a good opacity of the white image. Furthermore, the method includes thermally curing 110 the white ink layer on the textile fabric to obtain good washfastness. In one example, the pre-treatment composition can be applied to the textile fabric at from 10 gsm to 100 gsm. In another example, the heat applied to the pre-treatment layer on the textile fabric can range from 120° C. to 200° C. In some more specific examples, pressure can also be applied to the pre-treatment layer on the textile fabric can range from 1.5 psi to 120 psi. The heat (or the heat and the pressure) can be applied to pre-treatment layer on the textile fabric can be for a period of time ranging from 10 seconds to 30 minutes. The method can utilize the fluid sets and/or textile printing kits shown and described in FIGS. 1 and 2, and the components thereof described in greater detail by way of example hereinafter.

With more specific reference to FIG. 4, a schematic diagram 100B illustrating application of the fluid sets, textile printing kits, and methods of textile printing in the context of a printing system is depicted. As shown, there may be various printing steps carried out, which in an inline printing system, may occur in printing and/or coating “zones.” The zones may include application zones, such as a pre-treatment composition application zone (A), a fixer composition application zone (C), and/or a white ink application zone (D). As shown in this example, the application of the fixer composition and the white ink composition can occur in immediate sequence, so these two application zones may be merged into a single zone (Zone C/D), but likewise may be at different zones. There may also be heating zones, where heat and in some instances pressure applied. In this example, there are two heating zones e.g., pre-treatment heating zone (B) and an ink curing zone (E). In another example, the heating zones can be the same zone (B/E). Zones are shown by way of convenience, as coating and printing can occur in a single zone, or can occur in fewer or more zones that shown.

In one example, as an inline process by way of example, a substrate of textile fabric 18 may be transported through pre-treatment application zone (A) where a pre-treatment composition 12 is applied to the textile fabric to form a pre-treatment layer 112 thereon. In this example, the applicator shown is a sprayer nozzle 212, which is an analog applicator, but could be a digital application such as a digital ejector, e.g., inkjet ejector such as a thermal or piezoelectric digital droplet ejector, or could be another analog-type of applicator or auto-analog applicator, e.g., roller, drawdown coater, slot die coater, fountain curtain coater, blade coater, rod coater, air knife coater, sprayer, gravure application, brush, etc. In an example, the pre-treatment composition is applied as a pre-treatment layer in an amount up to about 100 gsm. In another example, the pre-treatment composition may be applied in an amount up to about 75 gsm. In still another example, the pre-treatment composition can be applied in an amount ranging from 10 gsm to 100 gsm, from 20 gsm to 100 gsm, or from 30 gsm to 80 gsm, for example.

Next, the pre-treatment layer 112 disposed on the textile fabric 18 may then be exposed to heat and pressure at a pre-treatment heating zone (B), where heat and pressure may be applied. In this example, the heat and pressure is shown being applied using a clam shell hot press 210A, 210B. Other heat applicators that can be used include a hot calendering roller, an iron, or another suitable heat and pressure applicator. In an example of the method, the application of heat and pressure involves heating the textile fabric 18 (with the pre-treatment composition 12 applied thereon) to a temperature (T) for a period of time (t) and at a pressure (P). The heat applied to pre-treatment layer on the textile fabric ranges from 80° C. to 200° C. The pressure applied to the pre-treatment layer on the textile fabric ranges from 1.5 psi to 120 psi, or 0.1 standard atmosphere (atm) to 8 atm. The heat and the pressure can be applied to pre-treatment layer on the textile fabric for a period of time ranging from 10 seconds to 30 minutes. In one example, the temperature ranges from 100° C. to 150° C., the pressure ranges from 7 psi to 75 psi, and the time ranges for 1 minute to 30 minutes.

During the application of heat and pressure, the siloxane or C10 to C24 alkyl chain-modified polymer from the emulsion in the pre-treatment composition 12 may coalesce to form a pre-treatment film, shown for the first time at (C) after application of heat and pressure, which acts to mat down a portion or even most/all of the hair-like fibers previously shown in FIG. 2 at 18A. The emulsion polymer, for example, coalesces and forms the film on the surfaces of the textile fabric fibers and/or in the pores between the textile fabric fibers. Next, the textile fabric 18 can be transported through fixer composition application zone (C) and white ink composition application zone (D). In these two “printing zones, an example of the fixer composition 14 is applied onto the pre-treatment film 112A using an fixer composition ejector 214, such as a digital inkjet printhead, to form a fixer layer 114, The fixer composition can be applied, for example, at a basis weight ranging from 10 gsm to 100 gsm, from 25 gsm to 100 gsm, or from 50 gsm to 75 gsm, for example. 50 gsm to 75 gsm. Next, a white ink composition 16 is applied onto the fixer layer using an ink composition ejector 216, such as a digital inkjet printhead, to form a white in layer 116. In one example, the white ink composition can be applied in an amount ranging from 100 gsm to 400 gsm, from 150 gsm to 400 gsm, or from 200 gsm to 350 gsm, for example. It is noted that in some examples, the fixer composition and the white ink composition can both be applied repeatedly (simultaneous or in series or in various combinations of layers, etc.) to achieve a targeted weight basis of both compositions. These printing or application steps are shown in this FIG. as being applied using carriage printheads, but may be fixed printheads where the media is moved near a print bar that is not on a carriage, for example. As a note the fixer layer may be dried (wet-on-dry) or not dried (wet-on-wet) prior to printing the white ink composition.

As shown at ink curing zone (E), fixer layer 114 and the white ink layer 116 may be heated (with or without pressure). In this example, the heating zone may again be a clam shell hot press, as shown, but alternatively, may be configured to apply heat without pressure, e.g., heated air drying with air temperatures from 40° C. to 90° C. to remove water and other volatile solvents that may be present. In other examples, the curing temperature may be from 80° C. to 200° C. In some examples, there may be an advantage to not disrupting the printed image with pressure, but in other examples, there may be an advantage to calendering the white image printed thereon. The resulting print may be a white image 120 printed on the textile fabric that has good image quality and durability.

In an example, the application of the pre-treatment composition, the fixer composition, and/or the white ink composition may be accomplished at a printing speed of 25 feet per minute (fpm) to 1200 fpm (or faster). In another example, the pre-treatment composition, the fixer composition, and/or the white ink composition may be applied at a printing speed ranging from 100 fpm to 1000 fpm, for example.

### Pre-Treatment Composition

Referring more specifically to the pre-treatment compositions shown at 12 and described in FIGS. 1-4, these compositions can include an emulsified polymer in a discontinuous phase and an aqueous liquid as a continuous phase. In some examples, the pre-treatment composition consists of the emulsified polymer and the aqueous liquid. In other examples, there may be other components present in the pre-treatment composition. The emulsified polymers herein may be referred to as dispersions because some siloxane polymer or C10 to C24 alkyl chain-modified polymer may be in the form of solids, depending on the temperature. As mentioned generally, the emulsified polymer can be an emulsified polysiloxane polymer or an emulsified C10 to C24 alkyl chain-modified polymer.

In further detail, the emulsified polysiloxane polymer can have a D50 particle size form 1 nm to 40 nm, from 2 nm to 35 nm, or from 4 nm to 30 nm, for example. The emulsified C10 to C24 alkyl chain-modified polymer may, on the other hand, have a D50 particle size from 5 nm to 1 μm, from 50 nm to 750 nm, or from 100 nm to 600 nm, for example. As used herein, particle size can refer to a value of the diameter of spherical particles or dispersed polymer of the emulsion, or in the case of particles or dispersed polymer masses that are not spherical, the particle size can be based on an equivalent spherical diameter of the volume of that particular particle if reshaped at the same density as a spherical particle. Furthermore, within these D50 particle size ranges, the particle size distribution of the emulsified polymer is not particularly limited. The particle size distribution can be in a Gaussian distribution or a Gaussian-like distribution (or normal or normal-like distribution). Gaussian-like distributions are distribution curves that can appear Gaussian in distribution curve shape, but which can be slightly skewed in one direction or the other (toward the smaller end or toward the larger end of the particle size distribution range). In these or other types of particle distributions, the particle size can be characterized using the 50th percentile of the particle size, referred to herein as the “D50” particle size. For example, a D50 value of 25 nm means that about 50% of the particles (by number) have a particle size greater than 25 nm and about 50% of the particles have a particle size less than 25 nm. Whether the particle size distribution is Gaussian, Gaussian-like, or otherwise, the particle size distribution can be expressed in terms of D50 particle size, which may typically approximate average particle size, but may not be the same. D50 particle size can be measured using a particle analyzer such as the Mastersizer™ 3000 available from Malvern Panalytical, for example. The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

In one example, the emulsified polysiloxane polymer can be emulsified to the particle size of 1 nm to 40 nm without added surfactant, which may contribute to pre-treatment compositions with good durability and image quality relative to larger sized emulsified polysiloxane polymer particles that may have been prepared with surfactant. With that in mind, in some more specific example, the pre-treatment composition as a whole may also be formulated without added surfactant so that the emulsified polysiloxane polymer prepared without surfactant remains surfactant-free as the pre-treatment composition. In one example, the emulsified siloxane polymer can include a substituted dimethyl silicone with a plurality of the otherwise methyl groups substituted with C1-C6 heteroatom-substituted alkyl, with C1-C6 heteroatom-substituted examples including 3-mercapto-propyl, 3-((2-aminoethyl)-amino)propyl, or a combination thereof. One specific example structure for the emulsified polysiloxane is shown in Formula I, as follows:

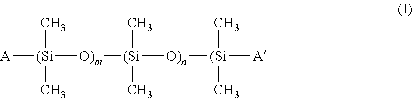

where A and A′ may independently be end cap groups, such as hydroxyl- or C1-C4 alkoxy-substituted methyl; B is C1-C6 heteroatom-substituted alkyl, e.g., 3-mercapto-propyl, 3-((2-aminoethyl)-amino)propyl, etc, where the term “heteroatom” includes sulfur, nitrogen, or oxygen; and m and n can be integers whose sum provides a polysiloxane having a weight average molecular weight from 1,000 Mw to 100,000 Mw, with a molar ratio of m to n ranging 1000:1 to 1:10, from 1000:1 to 1:1, from 1000:1 to 10:1, from 200:1 to 1:10, from 100:1 to 1:1, from 100:1 to 10:1, or from 50:1 to 2:1, for example. In another example, m can be 10 to 1,000, and n can be from 1 to 100. In some of these examples, there can be more m groups than n groups, or there can be 10 times or more m groups than n groups.

In another specific example, the emulsified polymer may be an emulsified C10 to C24 alkyl chain-modified polymer. For example, the C10 to C24 alkyl chain-modified polymer can be a stearylated polymer including a sidechain(s) with a C18 alkyl having a functional moiety attached thereto that includes one or more heteroatom, such as a stearyl amide, e.g., a stearyl acetamide, a stearyl amine, etc. Formula II shows one specific type of C10 to C24 alkyl chain-modified polymer that can be used in accordance with the present disclosure, as follows:

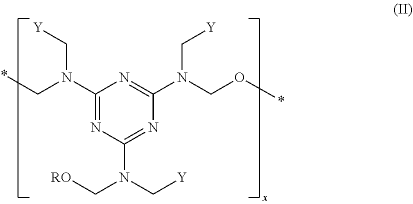

where Y represents a C10 to C24 alkyl chain, which can be functionalized as a C10 to C24 alkyl amide, such as a stearyl acetamide, e.g., CH₃(CH₂)₁₆(C(O)NH), a C10 to C24 alkyl amine, or another C10 to C24 alkyl group with a different functional moiety; R may be H, methyl, ethyl, or propyl (in two more specific examples, R may be H or R may be methyl); and x may be an integer selected so that the polymer has a weight average molecular weight from 1,000 Mw to 100,000 Mw, for example. In one example, x can be from 1 to 100. When x is 1 or a small integer where Formula II might otherwise be considered to be oligomeric, for convenience, such compositions are still defined herein to be “C10 to C24 alkyl chain-modified polymers,” as the Y groups a minimum of C10 in length. The asterisks (*) shown can represent hydrogen, lower alkyl, or an endcap group of any other type appropriate for capping the polymer when x is oligomeric or polymeric in nature.

As noted in the examples of the pre-treatment composition 12 disclosed herein, the pre-treatment composition includes emulsified siloxane polymer and/or emulsified C10 to C24 alkyl chain-modified polymer. The emulsified polymer, regardless of type or combination of the two types of polymers, can be present in the pre-treatment composition at from 4 wt % to 25 wt %, from 5 wt % to 20 wt %, or from 8 wt % to 15 wt %, based on a total weight of the pre-treatment composition. The pre-treatment composition thus includes a liquid component as a continuous phase of the pre-treatment composition (with the emulsified polymer, and in some instances other solids making up the discontinuous phase of the emulsion). The liquid phase of the emulsion can be referred to as a “pre-treatment vehicle” herein, and may be the liquid present in forming the emulsion, or may be further diluted with additional liquids. As the polymer emulsion is an aqueous emulsion, and water is present in the dispersion or emulsion as prepared, additional water may be added to form the pre-treatment compositions of the present disclosure, e.g., to dilute the polymer of the emulsion to a solids content (wt %) for the analog or digital application that is to be used to apply the pre-treatment composition. In some examples, water alone is the vehicle that is added to a surfactant-free polymer emulsion of siloxane polymer, or to an emulsified C10 to C24 alkyl chain-modified polymer, to generate the pre-treatment composition. In other examples, the pre-treatment vehicle may include liquid components other than water, e.g., organic co-solvent. In some instances, surfactant may be included, but as mentioned, in some instances, the emulsion may be free of surfactant, e.g., emulsified siloxane polymer in some examples.

The co-solvent in the pre-treatment composition 12, if included, may be a water soluble or water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers (e.g., DOWANOL™ TPM (from Dow Chemical), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl a

lcohol, butyl alcohol, and benzyl alcohol. Other specific examples include 2-ethyl-2-(hydroxymethyl)-1,3-propane diol (EPHD), dimethyl sulfoxide, sulfolane, and/or alkyldiols such as 1,2-hexanediol. The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin. The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine. In one specific example of the pre-treatment composition 12, the co-solvent includes 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. The co-solvent(s) may be present in an amount ranging from 0.1 wt % to 30 wt % (based on the total weight of the pre-treatment composition), or may be present at from 1 wt % to 30 wt %, from 2 wt % to 25 wt %, or from 4 wt % to 20 wt %.

The vehicle of the pre-treatment composition 12 may also include antimicrobial agent(s). Antimicrobial agents are also known as biocides and/or fungicides. In an example, the total amount of antimicrobial agent(s) in the pre-treatment composition ranges from 0.01 wt % to 0.05 wt % (based on active component within the total weight of the pre-treatment composition). In another example, the total amount of antimicrobial agent(s) in the pre-treatment composition is 0.044 wt % (based on active component within the total weight of the pre-treatment composition). Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

Examples of the pre-treatment composition 12 disclosed herein may have a viscosity ranging from 1 centipoise (cP) to 100 cP at a temperature of about 25° C. (measured at a shear rate of 3,000 Hz, e.g., with a Hydramotion Viscolite viscometer). Other viscosity ranges may be from 1 cP to 80 cP, from 3 cP to 60 cP, from 5 cP to 50 cP, from 20 cP to 100 cP, from 30 cP to 100 cP, from 1 cP to 30 cP, or from 2 cP to 20 cP, for example. Depending upon the viscosity, the pre-treatment composition may be applied on the textile fabric using an analog method or a digital method. It is to be understood that the viscosity of the pre-treatment composition may be adjusted for the type of analog coater that is to be used.

As an example, when the pre-treatment composition 12 is to be applied with an analog applicator, the viscosity of the pre-treatment composition may range from 1 cP to 100 cP (at 25° C. and a shear rate of 3,000 Hz). On the other hand, when the pre-treatment composition 12 is to be applied with a thermal inkjet printer or in a piezoelectric inkjet printer, the viscosity of the pre-treatment composition may be adjusted for the type of printhead that is to be used (e.g., by adjusting the co-solvent level). When used in a thermal inkjet printer, the viscosity of the pre-treatment composition may be modified to range from 1 cP to 15 cP (at 25° C. and a shear rate of 3,000 Hz), and when used in a piezoelectric printer, the viscosity of the pre-treatment composition may be modified to range from 1 cP to 30 cP (at 20° C. to 25° C. and a shear rate of 3,000 Hz). The viscosity of the pre-treatment composition that is to be inkjet printed may also be adjusted based on the type of the printhead that is being used, e.g., low viscosity printheads, medium viscosity printheads, or high viscosity printheads.

The pH of the pre-treatment composition 12 that includes the emulsified siloxane polymer may range from 3 to 7. The pH of the pre-treatment composition that includes the emulsified C10 to C24 alkyl chain-modified polymer may range from 7 to 10, for example.

In some specific examples, the pre-treatment composition 12 can further include other components (or other solids components) in addition to the emulsified polymer, e.g., emulsified polysiloxanes and/or emulsified C10 to C24 alkyl chain-modified polymer. For example, in some instances, the pre-treatment composition may include a polymeric binder. Examples of the polymeric binder may include anionic, cationic, and/or non-ionic polymeric binders. The polymeric binder selected may depend, in part, on the ionic state of the emulsion polymer that is used. For example, when an anionic polymer emulsion is used, anionic and/or non-ionic polymeric binders may be used. As another example, when a cationic emulsion polymer is used, cationic and/or non-ionic polymeric binders may be used. As still another example, when a non-ionic emulsion polymer is used, anionic, cationic, and/or non-ionic polymeric binders may be used. Examples of the polymeric binder may be, for example, a polyurethane-based binder selected from a polyester-polyurethane binder, a polyether-polyurethane binder, and a polycarbonate-polyurethane binder, an acrylic latex binder, or a combination thereof. In one specific example, the pre-treatment composition includes the polyester-polyurethane binder, which may be a sulfonated polyester-polyurethane binder, for example.

Polymer binders can have, for example, a particle size from 20 nm to 500 nm, from 50 nm to 350 nm, or from 100 nm to 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data generated by the NANOTRAC® Wave device. As mentioned, the term “average particle size” may refer to a volume-weighted mean diameter of a particle distribution.

In some examples of the pre-treatment composition 12, if the polymeric binder is present, it may be included at an amount ranging from 0.1 wt % to 20 wt %, from 1 wt % to 15 wt %, from 1 wt % to 10 wt %, or from 3 wt % to 8 wt %, based on a total weight of the pre-treatment composition. The polymeric binder (prior to being incorporated into the pre-treatment composition 12) may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the binder dispersion become part of the pre-treatment vehicle in the pre-treatment composition.

### Fixer Composition

A fixer composition, such as that shown at 14 and described in FIGS. 1-4, can include a cationic polymer and a fixer vehicle. In some examples, the fixer composition consists of the cationic polymer and the fixer vehicle. In other examples, the fixer composition may include additional components. The cationic polymer included in the fixer composition can have a weight average molecular weight ranging from 3,000 Mw to 3,000,000 Mw. Any weight average molecular weight (Mw) throughout this disclosure may be expressed as Mw, and is in Daltons. In some examples, e.g., when the fixer composition is to be thermally printed, the cationic polymer included in the fixer composition can have a weight average molecular weight from 3,000 Mw to 200,000, or from 3,000 Mw to 100,000 Mw, or from 3,000 Mw to 50,000 Mw, for example. This molecular weight may provide for the cationic polymer to be printed by thermal inkjet printheads with good print reliability in many instances. When using other technology to eject the fixer composition, higher molecular weights may be useable, such as from 200,000 Mw to 3,000,000 Mw, e.g., applied by piezoelectric printheads and/or analog methods.

Examples of the cationic polymer include poly(diallyldimethylammonium chloride); or poly(methylene-co-guanidine) anion with the anion is selected from the hydrochloride, bromide, nitrate, sulfate, or sulfonate; a polyamine; poly(dimethylamine-co-epichlorohydrin); a polyethylenimine; a polyamide epichlorohydrin resin; a polyamine epichlorohydrin resin; or a combination thereof. Some examples of commercially available polyamine epichlorohydrin resins may include CREPETROL™ 73, KYMENE™ 736, KYMENE™ 736NA, POLYCUP™ 7360, and POLYCUP™ 7360A, each of which is available from Solenis LLC.

In an example, the cationic polymer of the fixer composition 14 can be present in an amount ranging from 0.5 wt % to 15 wt % based on a total weight of the pre-treatment composition. In other examples, the cationic polymer is present in an amount ranging from 1 wt % to 15 wt %, from 1 wt % to 10 wt %, from 4 wt % to 8 wt %, from 2 wt % to 7 wt %, or from 6 wt % to 10 wt %, based on a total weight of the pre-treatment composition

The fixer composition can further include a fixer vehicle to carry the cationic polymer, for example. As used herein, the term “fixer vehicle” may refer to the liquid in which the cationic polymer is mixed to form the fixer composition. The fixer vehicle can be an aqueous vehicle including water, and may include other liquid components, such as organic co-solvent, surfactant, chelating agent, a pH adjuster, etc.

If a surfactant is included, the surfactant in the fixer composition 14 may be an anionic, non-ionic, or cationic surfactant in any amount set forth herein based on a total weight of the fixer composition. The surfactant may be present in an amount ranging from 0.01 wt % to 5 wt % (based on the total weight of the fixer composition). In an example, the surfactant is present in the fixer composition in an amount ranging from 0.05 wt % to 3 wt %, based on the total weight of the fixer composition. In another example, the surfactant is present in the white ink composition in an amount of 0.3 wt %, based on the total weight of the fixer composition.

The co-solvent in the fixer composition 14 may be any example of the co-solvents set forth herein for the pre-treatment composition 12 previously, in any amount set forth herein for the pre-treatment composition (except that the amount(s) are based on the total weight of the fixer composition instead of the pre-treatment composition).

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate. Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

A chelating agent may be present in the fixer composition in an amount from 0.01 wt % to 0.5 wt % based on the total weight of the fixer composition. In an example, the chelating agent is present in an amount ranging from 0.05 wt % to 0.2 wt % based on the total weight of the fixer composition. The chelating agent may be selected from methylglycinediacetic acid, trisodium salt; 4,5-dihydroxy-1,3-benzenedisulfonic acid disodium salt monohydrate, ethylenediaminetetraacetic acid (EDTA), hexamethylenediamine tetra(methylene phosphonic acid), potassium salt, or a combination thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

A pH adjuster may also be included in the fixer composition 14, such as to achieve a target pH level, e.g., from 1 to 7 pH, from 2 to 6 or from 3 to 4, and/or to counteract any slight pH increase that may occur over time or during formulation. In an example, the total amount of pH adjuster(s) in the fixer composition, if used, can be from 0.01 wt % to 0.5 wt %, based on the total weight of the fixer composition. In another example, the total amount of pH adjuster(s) in the fixer composition can be from 0.02 wt % to 0.1 wt %, based on the total weight of the fixer composition. An example of a pH adjuster that may be used in the fixer composition includes methane sulfonic acid.

The viscosity of the fixer composition 14 may vary depending upon the application method that is to be used to apply the fixer composition. As an example, when the fixer composition is to be applied with an analog applicator, the viscosity of the fixer composition may range from 1 centipoise (cP) to 300 cP (at 25° C. and a shear rate of 3,000 Hz), from 10 cP to 300 cP, or from 20 cP to 300 cP. As other examples, when the fixer composition is to be applied with an thermal inkjet applicator/printhead, the viscosity of the fixer composition may range from 1 cP to 15 cP (at 25° C. and a shear rate of 3,000 Hz), and when the fixer composition is to be applied with an piezoelectric inkjet applicator/printhead, the viscosity of the fixer composition may range from 1 cP to 30 cP (at 25° C. and a shear rate of 3,000 Hz).

### White Ink Composition

A white ink composition 16 includes a white pigment, a polymeric binder, and an ink vehicle. In some examples, the white ink composition consists of the white pigment, the polymeric binder, and the ink vehicle. In other examples, the white ink composition may include additional components.

Examples of suitable white pigments include white metal oxide pigments, such as titanium dioxide (TiO₂), zinc oxide (ZnO), zirconium dioxide (ZrO₂), or the like. In one example, the white pigment includes or is titanium dioxide. In an example, the titanium dioxide may be in its rutile form. In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. In other examples, the white pigment may be co-dispersed with pigments that are not white per se, but may enhance the opacity of the white pigment by preventing the white pigment from becoming packed tightly, e.g., silica particles, alumina particles, etc. One example of the white pigment includes TI-PURE® R960 (TiO₂ pigment powder with 5.5 wt % silica and 3.3 wt % alumina (based on pigment content)) available from Chemours. Another example of the white pigment includes TI-PURE® R931 (TiO₂ pigment powder with 10.2 wt % silica and 6.4 wt % alumina (based on pigment content)) available from Chemours. Still another example of the white pigment includes TI-PURE® R706 (TiO₂ pigment powder with 3.0 wt % silica and 2.5 wt % alumina (based on pigment content)) available from Chemours.

The white pigment may have high light scattering capabilities, and the average particle size of the white pigment may be selected to enhance light scattering and lower transmittance, thus increasing opacity. The average particle size of the white pigment may range anywhere from 100 nm to 2000 nm. In some examples, the average particle size ranges from 120 nm to 2000 nm, from 150 nm to 1000 nm, from 150 nm to 750 nm, or from 200 nm to 500 nm. The term “average particle size”, as used herein, may refer to a volume-weighted mean diameter of a particle distribution.

In an example, the white pigment is present in an amount ranging from 1 wt % to 20 wt %, based on a total weight of the white ink composition 16. In other examples, the white pigment is present in an amount ranging from 3 wt % to 20 wt %, from 5 wt % to 20 wt %, from 5 wt % to 15 wt %, or from 1 wt % to 10 wt %, based on a total weight of the white ink composition 16. In still another example, the white pigment is present in an amount of 10 wt % or 9.75 wt %, based on a total weight of the white ink composition.

The white pigment may be dispersed with the pigment dispersant, such as a water-soluble acrylic acid polymer, a branched co-polymer of a comb-type structure with polyether pendant chains and acidic anchor groups attached to a backbone, or a combination thereof. Other dispersants may also be used. Some examples of the water-soluble acrylic acid polymers that can be used as dispersants include CARBOSPERSE® K7028 (polyacrylic acid having a weight average molecular weight (Mw) of 2,300), CARBOSPERSE® K752 (polyacrylic acid having a weight average molecular weight (Mw) of 2,000), CARBOSPERSE® K7058 (polyacrylic acid having a weight average molecular weight (Mw) of 7,300), and CARBOSPERSE® K732 (polyacrylic acid having a weight average molecular weight (Mw) of 6,000), all available from Lubrizol Corporation. Some examples of the branched co-polymer of the comb-type structure with polyether pendant chains and acidic anchor groups attached to the backbone include DISPERBYK®-190 (an acid number of 10 mg KOH/g) and DISPERBYK®-199, both available from BYK Additives and Instruments, as well as DISPERSOGEN® PCE available from Clariant. In some examples, the pigment dispersant includes both the water-soluble acrylic acid polymer and the branched co-polymer of the comb-type structure with polyether pendant chains and acidic anchor groups attached to the backbone. In some of these examples, the pigment dispersant includes CARBOSPERSE® K7028 and DISPERBYK®-190. In some of these examples, the pigment dispersant includes both the water-soluble acrylic acid polymer and the branched co-polymer of the comb-type structure with polyether pendant chains and acidic anchor groups attached to the backbone, where the water-soluble acrylic acid polymer is present in an amount ranging from 0.02 wt % to 0.4 wt %, and the branched co-polymer of the comb-type structure with polyether pendant chains and acidic anchor groups attached to the backbone is present in an amount ranging from 0.03 wt % to 0.6 wt %. In one of these examples, the water-soluble acrylic acid polymer is present in an amount of 0.09 wt %, and the branched co-polymer of the comb-type structure with polyether pendant chains and acidic anchor groups attached to the backbone is present in an amount of 0.14 wt %.

In some examples, the pigment dispersant(s) may be present in an amount ranging from 0.05 wt % to 1 wt %, based on a total weight of the white ink composition 16. In one of these examples, the dispersant is present in an amount of 0.1 wt % to 0.75 wt %, based on a total weight of the white ink composition.

The white ink composition 16 may also include a polymeric binder. The polymeric binder in the white ink composition may be any example of the anionic polymeric binders or the non-ionic polymeric binder set forth herein for the pre-treatment composition 12, in any amount set forth herein for the pre-treatment composition (except that the amount(s) are based on the total weight of the white ink composition instead of the pre-treatment composition). The polymeric binder (prior to being incorporated into the white ink composition) may be dispersed in water alone or in combination with an additional water soluble or water miscible co-solvent, such as those described for the pigment dispersion. It is to be understood however, that the liquid components of the binder dispersion become part of the ink vehicle in the white ink composition.

The white pigment may be incorporated into the white ink composition 16 as a white pigment dispersion. The white pigment dispersion may include a white pigment and a separate pigment dispersant, for example. For the white pigment dispersions disclosed herein, it is to be understood that the white pigment and separate pigment dispersant (prior to being incorporated into the ink formulation), may be dispersed in water alone or in combination with additional water-soluble or water miscible co-solvent(s). Likewise, the dispersion can be formulated into a white ink composition by adding additional components to the dispersion, similar to that in the dispersion, or by adding additional components. Example organic co-solvents that can be included in the white pigment dispersion or further added to formulation the white in composition include co-solvents such as 2-pyrrolidone, 1-(2-hydroxyethyl)-2-pyrrolidone, glycerol, 2-methyl-1,3-propanediol, 2,2-dimethyl-1,3-propanediol, 1,2-butane diol, diethylene glycol, 1,3-propanediol, 1,4-butanediol, 1,5-pentanediol, triethylene glycol, tetraethylene glycol, hexylene glycol, or a combination thereof. It is to be understood however, that the liquid components of the white pigment dispersion become part of the ink vehicle in the white ink composition, or the solvents can be added to dispersions in formulating the white ink compositions. Other co-solvents mentioned herein, such as in the context of the pre-treatment coating composition, as well as others, can likewise be used.

Thus, in addition to the white pigment and any other solids that may be present, e.g., polymeric binder, the white ink composition includes an ink vehicle. As used herein, the term “ink vehicle” may refer to the liquid with which the white pigment (dispersion) and any other solids are dispersed to form a white ink composition. A wide variety of vehicles may be used with the white ink composition(s) of the present disclosure. The ink vehicle may include water and any of a co-solvent, an anti-kogation agent, an anti-decel agent, a surfactant, an antimicrobial agent, a pH adjuster, or combinations thereof. In an example of the ink white ink composition, the vehicle includes water and a co-solvent. In another example, the vehicle consists of water and the co-solvent, the anti-kogation agent, the anti-decel agent, the surfactant, the antimicrobial agent, a pH adjuster (e.g., to achieve a pH from 5 to 9), or a combination thereof. In still another example, the ink vehicle consists of the anti-kogation agent, the anti-decel agent, the surfactant, the antimicrobial agent, a pH adjuster, and water.

Examples of the white ink composition 16 disclosed herein may be used in a thermal inkjet printer or in a piezoelectric printer. The viscosity of the white ink composition may be adjusted for the type of printhead by adjusting the co-solvent level, adjusting the polymeric binder level, and/or adding a viscosity modifier. When used in a thermal inkjet printer, the viscosity of the white ink composition may be modified to range from 1 cP to 15 cP (at 25° C. measured at a shear rate of 3,000 Hz). When used in a piezoelectric printer, the viscosity of the white ink composition may be modified to range from 1 cP to 30 cP (at 25° C. measured at a shear rate of 3,000 Hz), depending on the type of the printhead that is being used, e.g., low viscosity printheads, medium viscosity printheads, or high viscosity printheads.

### Textile Fabrics

In the examples disclosed herein, the textile fabric 18, shown in FIGS. 2 and 4, may be constructed from a fabric material polyester, polyester blend, cotton, cotton blend, nylon, nylon blend, silk fabrics, silk blend fabrics, wool fabrics, wool blend fabrics, or a combination thereof. In a further example, the textile fabric is selected from the cotton fabrics or cotton blend fabrics. It is to be understood that organic textile fabrics and/or inorganic textile fabrics may be used for the textile fabric 18. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric 18 can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In an example, natural and synthetic fibers may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

In addition, the textile fabric 18 can contain additives, such as a colorant (e.g., pigments, dyes, and tints), an antistatic agent, a brightening agent, a nucleating agent, an antioxidant, a UV stabilizer, a filler, and/or a lubricant, for example.

The terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

In one example, the textile fabric 18 can have a basis weight ranging from 10 gsm to 500 gsm. In another example, the textile fabric can have a basis weight ranging from 50 gsm to 400 gsm. In other examples, the textile fabric can have a basis weight ranging from 100 gsm to 300 gsm, from 75 gsm to 250 gsm, from 125 gsm to 300 gsm, or from 150 gsm to 350 gsm.

The textile fabric 18 may be any color, and in example, is a color other than white. In further detail, the color can be a dark color, such as a color having an L* value from 20 to 50, or from 25 to 35, for example.

It is noted that, as used in this specification and the appended claims, the singular forms “a,” “an,” and “the” include plural referents unless the content clearly dictates otherwise.

As used herein, weight percentage that is often referred to as “wt %,” which typically refers to the loading of the specifically listed component, or active ingredient, unless noted otherwise, even if that component was supplied with other ingredients. For example, a white pigment may be present in a water-based pigment dispersion formulation, e.g., a stock solution or dispersion, before being incorporated into the white ink composition. In this example, the wt % of the white pigment accounts for the loading (as a weight percent) of the white pigment(s) per se that is present in the white ink composition, and does not account for the weight of the other components, e.g., water, etc., that are present in the formulation with the white pigment. If a percentage is given without identifying the type of percentage, it understood to be weight percent unless the context is clearly otherwise.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those in the field technology determine based on experience and the associated description herein.

As used herein, a plurality of items, structural elements, compositional elements, and/or materials may be presented in a common list for convenience. However, these lists should be construed as though individual member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also all the individual numerical values or sub-ranges encompassed within that range as if individual numerical values and sub-ranges are explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

### Example 1—Preparation of Pre-treatment Compositions

Four examples of the pre-treatment composition disclosed herein were prepared with either a surfactant-free emulsified siloxane polymer (PT1-PT3) or with a stearylated polymer emulsion (PT4). For comparison, two comparative pre-treatment compositions (“Comp. PT5” and “Comp. PT6”) were prepared which included silicone emulsions with surfactant emulsifier. To prepare the pre-treatment compositions (which includes the comparative pre-treatment compositions), six different commercially available formulations were diluted with deionized water to obtain respective pre-treatment compositions having 10 wt % emulsified polymer. The surface tension, viscosity, pH, and average particle size, e.g., volume-weighted mean diameter (Mᵥ) in nanometers (nm), were measured for all six samples. The surface tension was measured by the Wilhelmy plate method with a Kruss tensiometer. The viscosity was measured at room temperature (25° C.) using a Viscolite viscometer. The particle size was measured using a NANOTRAC® Wave device, from Microtrac. Pre-treatment composition properties were measured and are shown in Table 1.

TABLE 1
Pre-Treatment Compositions (PTI-PT4 and Comparative PT5-PT6)

| | | | | | | Polymer |
|---|---|---|---|---|---|---|
| | Emulsion Polymer | | Surface | | | Particle |
| | (diluted to 10 wt % | Emulsified | Tension | Viscosity | | Size, Mᵥ |
| ID | polymer content) | Polymer Type | (mN/m) | (cP) | pH | (nm) |
| PT1 | WACKER ® FC 204 | Emulsified | 34.81 | 2.0 | 5.29 | 23 |
| | | Surfactant-free | | | | |
| | | Siloxane Polymer | | | | |
| PT2 | WACKER ® HC 303 | Emulsified | 29.03 | 2.1 | 5.09 | 10 |
| | | Surfactant-free | | | | |
| | | Siloxane Polymer | | | | |
| PT3 | ICM EM 1612 | Emulsified | 22.57 | 5.4 | 4.87 | 5 |
| | | Surfactant-free | | | | |
| | | Siloxane Polymer | | | | |
| PT4 | SEQUAPEL ® 409 | Emulsified | 54.18 | 1.1 | 8.25 | 548 |
| | | Stearylated | | | | |
| | | Polymer | | | | |
| Comp. | ICM EM 100 | Emulsified | 27.93 | 1.1 | 4.26 | 279 |
| PT5 | | Siloxane Polymer | | | | |
| | | with Surfactant | | | | |
| Comp. | WACKER ® FC 218 | Emulsified | 25.25 | 1.2 | 6.84 | 50 |
| PT6 | | Siloxane Polymer | | | | |
| | | with Surfactant | | | | |

WACKER ® FC 204 includes an emulsified a sulfur-alkyl substituted dimethyl siloxane polymer without surfactant emulsifier, and is available from Wacher Chemie AG (Germany).
WACKER ® HC 303 includes an emulsified diamino-alkyl substituted dimethyl siloxane polymer, and is available from Wacher Chemie AG (Germany).
ICM EM 1612 includes an emulsified amino-alkyl substituted dimethyl siloxane polymer, and is available from Omnova Solutions (USA).
SEQUAPEL ® 409 includes an emulsion of a stearylated polymer, and is available from Omnova Solutions (USA).
ICM EM 100 includes a surfactant emulsified dimethyl siloxane polymer which includes a surfactant emulsifier, and is available from Omnova Solutions (USA).
WACKER ® FC 218 includes a surfactant emulsified diamino-alkyl substituted dimethyl siloxane polymer, and is available from Wacher Chemie AG (Germany).

### Example 2—Preparation of Fixer Composition

An example fixer composition as disclosed herein was prepared. The general formulation of the example fixer composition is shown in Table 2, with the wt % of each component that was used.

TABLE 2
Fixer Composition (F1)

| Component | | wt % |
|---|---|---|
| 2-pyrrolidone | Organic Co-solvent | 12 |
| POLYCUP ™ 7360A | Cationic Polymer | 4 |
| SURFYNOL ® 440 | Surfactant | 0.3 |
| Deionized water | Water | Balance |

POLYCUP ™ 7360A includes a polyamine epichlorohydrin, and is available from Solenis LLC (USA).
SURFYNOL ® 440 is a nonionic surfactant, and is available from Evonik (Germany).

### Example 3—Preparation of White Ink Composition (W1)

An example white ink composition as disclosed herein was also prepared. The general formulation of example white ink is shown in Table 3, with the wt % of each component that was used (e.g., wt % white pigment). A 5 wt % potassium hydroxide aqueous solution was added until a pH of 8.5 was achieved.

TABLE 3
White ink composition (W1)

| Specific Component | Active Ingredient Type | wt % |
|---|---|---|
| White pigment dispersion | TiO₂-based | 10 |
| | Pigment dispersion | |
| Glycerol | Organic Co-solvent | 9 |
| Tripropylene Glycol Methyl | Organic Co-solvent | 1 |
| Ether | | |
| LIPONIC ® EG-1 | Organic Co-solvent | 2 |
| SURFYNOL ® 440 | Surfactant | 0.3 |
| ACTICIDE ® B20 | Antimicrobial agent | 0.2 (as is) |
| IMPRANIL ® DLN-SD | Polyurethane Binder | 8 |
| Deionized water | Solvent | Balance |

5 wt % Potassium Hydroxide Aqueous Solution Added Until pH 8.5 Reached
SURFYNOL ® 440 is a nonionic surfactant, and is available from Evonik (Germany).

### Example 4—White Image Quality and Durability on Dark Textile Fabric

Gildan black mid-weight 780 cotton T-shirts (having a basis weight of 180 gsm) were used as the textile fabric substrates in this example. More specifically, several black textile fabric samples (F1-F14) were individually pre-treated with pre-treatment compositions PT1-PT4 as well as comparative pre-treatment compositions Comp. PT5 and Comp. PT6, with water an equivalent amount of water to wet the fabric similarly to that of the pre-treatment compositions, or with nothing. If a pre-treatment composition was applied, it was applied at around 60 grams per square meter (gsm) based on the weight of the liquid formulation. Some variability of the weight basis was noted, with weight basis application ranging from 53.8 gsm to 68.3 gsm. The pre-treatment coating compositions were applied to the black textile fabric substrates using an analog spraying technique. Many of the pre-treated fabrics were exposed to 150° C. and pressure of 44 pounds per square inch (psi), which is 3 atm. The heat and pressure were applied using a clam shell hot press for 1 minute. Several other samples were simply air dried at room temperature, rather than under heat and pressure.

After the 14 fabric substrate samples (F1-F14) were pre-treated with pre-treatment composition or with water (or with nothing, as was the case with F14), example prints were generated using the fixer composition (F1) of Example 2 applied at 55 gsm, followed by the white ink composition (W1) of Example 3 at 300 gsm. The prints were generated using a thermal inkjet printhead (6 passes) via wet on wet printing, e.g., W1 on F1 while the fixer was still wet. The black textile fabrics imaged with the white ink were then heat cured at 150° C. for 3 minute at 44 psi of pressure.

All 14 printed textile fabric samples were then tested for washfastness and image quality. For washfastness, an initial L*a*b* value of the white images on the black textile fabric was measured, and then a second L*a*b* value for the white images was collected after the 5 washes. L* is lightness, a* is the color channel for color opponents green-red, and b* is the color channel for color opponents blue-yellow. The 5 washes were carried out using a Whirlpool Washer (Model WTW5000DW) with warm water (at 40° C.) and standard washing machine detergent. Each of the printed textile fabric samples were allowed to air dry between washes.

The color change ΔE was calculated by:

ΔE_{CIE}=[(ΔL*)²+(Δa*)²(Δb*)²]^{0.5}

Additionally, optical microscope images were taken at locations where the white printed image was located on the various printed textile fabric samples. The quality of the images was visually assessed, and was designated “Poor” (fibers sticking up through the image with very non-uniform white coloration), “Marginal” (more uniform than “poor”, but fibers still sticking up through the image), “Good” (uniform print surface, very few fibers sticking up), and “Very Good (uniform print surface, no fibers sticking up).

The washfastness (Durability) and optical microscope (Image Quality) data is presented in Table 4, as follows:

TABLE 4

| | Pre- | | | | | |
|---|---|---|---|---|---|---|
| Fabric | treatment ID | Heat (150° C.) | | | | |
| Sample | (Weight | Pressure (44 psi) | Initial | L* after 5 | | Image |
| ID | Basis) | Time (1 minute) | L* | washes | ΔE_{CIE} | Quality |
| 1 | PT1 | Yes | 90.1 | 89.8 | 0.27 | Very Good |
| | (62.7 gsm) | | | | | |
| 2 | PT2 | Yes | 91.8 | 91.7 | 0.21 | Very Good |
| | (61.1 gsm) | | | | | |
| 3 | PT3 | Yes | 91.2 | 905 | 0.79 | Very Good |
| | (68.1 gsm) | | | | | |
| 4 | PT4 | Yes | 88.4 | 86.8 | 1.62 | Very Good |
| | (61.4 gsm) | | | | | |
| 5 | Water | Yes | 79.9 | 80.0 | 0.38 | Marginal |
| | (67.5 gsm) | | | | | to Good |
| 6 | Comp. PT5 | Yes | 79.5 | 80.0 | 0.38 | Marginal |
| | (62.9 gsm) | | | | | |
| 7 | Comp. PT6 | Yes | 84.3 | 82.7 | 1.55 | Marginal |
| | (59.9 gsm) | | | | | to Good |
| 8 | PT1 | No* | 83.3 | 83.3 | 0.31 | Poor |
| | (53.8 gsm) | | | | | |
| 9 | PT2 | No* | 83.1 | 82.2 | 0.92 | Poor |
| | (64.7 gsm) | | | | | |
| 10 | PT3 | No* | 84.2 | 85.4 | 1.24 | Poor to |
| | (68.3 gsm) | | | | | Marginal |
| 11 | Water | No* | 76.6 | 76.8 | 0.32 | Poor |
| | (65.8 gsm) | | | | | |
| 12 | Comp. PT5 | No* | 78.8 | 78.8 | 0.10 | Poor |
| | (64.7 gsm) | | | | | |
| 13 | Comp. PT6 | No* | 84.9 | 84.0 | 0.93 | Poor |
| | (60.2 gsm) | | | | | |
| 14 | None | No* | 78.2 | 78.8 | 0.58 | Poor |

*“No” indicates that the sample was air dried at room temperature until dry.

As can be seen in Table 4, the white prints on black cotton fabrics pre-treated with the pre-treatment compositions of the present disclosure, e.g., PT1-PT4, when heat-pressed prior to printing, exhibited an initial L* value above 88, which is very good for white ink, with the emulsified siloxane polymer providing L* values above 90. Conversely, with the various comparative examples (Comp. PT5, Comp. PT6, or water as the pre-treatment composition), even when using the heat press, the initial L* value ranged from 70.4 to 84.3, which was inferior to the data generated using pre-treatment compositions PT1-PT4.

Regarding image quality, as noted, the use of PT1-PT4 with white inks to print white images were all noted as “Very Good,” when printed and heat/pressure applied to the pre-treatment composition on the black fabric prior to printing the white ink thereon. Notably, heat was also applied to all of the samples after printing the white ink, but the heat and pressure metric of this table relates to applying heat and pressure to the pre-treatment layer prior to printing. For the comparative examples where heat and pressure was applied to the pre-treatment composition on the textile fabric substrate (Comp. PT5, Comp. PT6, and Water), the results were from marginal to marginal/good, as there was, at minimum, fibers sticking up in the image. No score of “good” was given for the comparative examples, which still would have been a full grading step below “very good” as achieved by PT1-PT4. As a note, when any of the samples were air dried after application of the pre-treatment coating composition (PT1-PT4, as well as Comp. PT5, Comp. PT6, or water), the image quality was poor.

With respect to durability, even though the ΔE and the change in L* for pre-treatment compositions (with heat and pressure application prior to printing) appears to be the same or around the same level of performance for both the example pre-treatment coatings (PT1-PT4) and the comparative pre-treatment coatings (Comp. PT5 and Comp. PT6), in actuality, the data tended to be better for the example pre-treatment coatings (PT1-PT4) as the prints started with higher L* values, and thus retaining this higher level of L* brightness means that the prints will look better after 5 washes than the initial L* values of other samples starting with a lower L* value. In fact, in many instances, the comparative example pre-treatment coatings initially had about the same L* values (prior to wash challenge) as that after 5 washes when using pre-treatment coating compositions PT1-PT4.

While several examples have been described in detail, it is to be understood that the disclosed examples may be modified. Therefore, the foregoing description is to be considered non-limiting.

What is claimed is:

1. A fluid set for textile printing, comprising:
a pre-treatment composition having an emulsified polymer therein, the emulsified polymer including:
an emulsified siloxane polymer having a D50 particle size from 1 nm to 40 nm,
an emulsified C10 to C24 alkyl chain-modified polymer, or
a combination thereof;
a fixer composition including a cationic polymer and a fixer vehicle; and
a white ink composition including a white pigment, a polymeric binder, and an ink vehicle.

2. The fluid set of claim 1, wherein the pre-treatment composition includes the emulsified siloxane polymer, and the emulsified siloxane polymer includes a substituted dimethyl silicone with a plurality of methyl groups substituted with 3-mercapto-propyl, 3-((2-aminoethyl)-amino)propyl, or a combination thereof.

3. The fluid set of claim 1, wherein the pre-treatment composition includes the emulsified C10 to C24 alkyl chain-modified polymer in the form of an emulsified stearylated polymer, and wherein the emulsified stearylated polymer has as D50 stearylated polymer size from 5 nm to 1 μm.

4. The fluid set of claim 1, wherein the emulsified polymer is the emulsified siloxane polymer having a weight average molecular weight from 1,000 Mw to 100,000 Mw, or wherein the emulsified polymer is the emulsified C10 to C24 alkyl chain-modified polymer having a weight average molecular weight from 1,000 Mw to 100,000 Mw.

5. The fluid set of claim 1, wherein the pre-treatment composition is an analog application fluid or a digital printing fluid with a viscosity from 1 cps to 100 cps at 25° C., and wherein the fixer composition and the white ink composition are both digital printing fluids individually having viscosities from 1 cps to 30 cps at 25° C.

6. The fluid set of claim 1, wherein the emulsified polymer is present in the pre-treatment composition at from 4 wt % to 25 wt %.

7. The fluid set of claim 1, wherein the cationic polymer of the fixer composition is selected from poly(diallyldimethylammonium chloride); or poly(methylene-co-guanidine) anion with the anion is selected from the hydrochloride, bromide, nitrate, sulfate, or sulfonate; a polyamine; poly(dimethylamine-co-epichlorohydrin); a polyethylenimine; a polyamide epichlorohydrin resin; a polyamine epichlorohydrin resin; or a combination thereof.

8. The fluid set of claim 1, wherein the white pigment includes titanium dioxide, zinc oxide, zirconium dioxide, or a combination thereof, and is present in the white ink composition at from 4 wt % to 15 wt %.

9. The fluid set of claim 1, wherein the pre-treatment composition includes the emulsified siloxane polymer, and the emulsified siloxane polymer is emulsified in the absence of a surfactant.

10. A textile printing kit, comprising:
a textile fabric; and
a pre-treatment composition having an emulsified polymer therein, the emulsified polymer including:
an emulsified siloxane polymer having a D50 particle size from 1 nm to 40 nm,
an emulsified C10 to C24 alkyl chain-modified polymer, or
a combination thereof;
a fixer composition including a cationic polymer and a fixer vehicle, and
a white ink composition including a white pigment, a polymeric binder, and an ink vehicle.

11. The textile printing kit of claim 10, wherein the textile fabric is selected from polyester fabric, polyester blend fabric, cotton fabric, cotton blend fabric, nylon fabric, nylon blend fabric, silk fabric, silk blend fabric, wool fabric, wool blend fabric, or a combination thereof.

12. The textile printing kit of claim 10, wherein the textile fabric is a dark fabric having an L* value from 20 to 50.

13. A textile printing method, comprising:
applying a pre-treatment composition on a textile fabric to form a pre-treatment layer, the pre-treatment composition including an emulsified siloxane polymer having a D50 particle size from 1 nm to 40 nm, an emulsified C10 to C24 alkyl chain-modified polymer, or a combination thereof;
applying heat to the pre-treatment layer on the textile fabric to form a pre-treatment film;
applying a fixer composition on the pre-treatment film to form a fixer layer, the fixer composition including a cationic polymer and a fixer vehicle;
digitally printing a white ink composition on the fixer layer to form a white ink layer, the white ink composition including a white pigment, a polymeric binder, and an ink vehicle; and
thermally curing the white ink layer on the textile fabric to form a white image.

14. The method of claim 13, wherein the pre-treatment composition is digitally printed on the textile fabric at from 10 gsm to 100 gsm.

15. The method of claim 13, further comprising applying pressure to the pre-treatment layer on the textile fabric, wherein the heat applied to the pre-treatment layer on the textile fabric ranges from 120° C. to 200° C. and the pressure applied to the pre-treatment layer on the textile fabric ranges from 1.5 psi to 120 psi, and wherein the heat and the pressure are applied to pre-treatment layer on the textile fabric for a period of time ranging from 10 seconds to 30 minutes.
